(19) United States
(12) Patent Application Publication
(10) Pub. No.: US 2017/0051186 A1
(43) Pub. Date: Feb. 23, 2017

(54) ADHESIVE COMPOSITION AND COMPOSITE MATERIAL USING SAME

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP); Kyushu University, Fukuoka-shi, Fukuoka (JP)

(72) Inventors: Tatsuya HASE, Yokkaichi, Mie (JP); Kazuo NAKASHIMA, Yokkaichi, Mie (JP); Makoto MIZOGUCHI, Yokkaichi, Mie (JP)

(73) Assignees: AutoNetworks Technologies, Ltd., Mie (JP); Sumitomo Wiring Systems, Ltd., Mie (JP); Sumitomo Electric Industries, Ltd., Osaka (JP); Kyushu University, Fukuoka (JP)

(21) Appl. No.: 15/119,690

(22) PCT Filed: Jan. 29, 2015
(86) PCT No.: PCT/JP2015/052427

§ 371 Date: Aug. 17, 2016

(30) Foreign Application Priority Data
Feb. 19, 2014 (JP) 2014029086
Feb. 19, 2014 (JP) 2014029246

(51) Int. Cl. C09J 11/06; B32B 7/12; B32B 3/08; B32B 15/20; B32B 15/085; C09J 11/04; B32B 15/04

(52) U.S. Cl. CPC C09J 11/06; C09J 11/04; B32B 7/12; B32B 15/043; B32B 15/20; B32B 15/085; B32B 3/08; B32B 2250/02; B32B 2255/06; B32B 2255/24

(57) ABSTRACT

An adhesive composition that is capable of functioning alone as an adhesive component without using a curable resin, and adhering to integrate an inorganic material and an organic material, and a composite material using the same. The adhesive composition contains an adduct containing an acidic phosphate ester comprising one or more kinds of compounds represented by General Formulae (1) and (2), and a metal. The composite material includes one material, the other material, and an adhesive composition disposed between the materials to adhere to the materials, the one material and the other material being integrated by the adhesive composition. P(═O)(—OR₁)(—OH)₂ . . . (1), and P(═O)(—OR₁)₂(—OH) . . . (2), where R₁ represents an aliphatic hydrocarbon group having 4 to 30 carbon atoms, and has one or more branched chain structures, or one or more carbon-carbon double bond structures.

### CROSS REFERENCE TO RELATED APPLICATIONS

This application claims the priority of Japanese patent application JP2014-029086 filed on Feb. 19, 2014 and JP2014-029246 filed on Feb. 19, 2014, the entire contents of which are incorporated herein.

### TECHNICAL FIELD

The present invention relates to an adhesive composition and a composite material using the same.

### BACKGROUND ART

An inorganic material such as a metal material and an organic material such as a resin material have properties different from each other, so that it is often difficult to bond them to each other; however, to bond and integrate an inorganic material and an organic material is very significant in a variety of material fields. For this reason, a material to firmly bond these materials is required.

For example, Patent Document 1 (JP497575) relates to a dental material, and describes that a specific phosphate ester compound or a metal salt thereof is used together with a (meth)acrylic ester compound that is a polymerizable compound.

### SUMMARY OF INVENTION

However, the phosphate ester compound or the metal salt thereof of Patent Document 1, which is a special kind of phosphate ester compound that has an aromatic ring or a metal salt thereof, needs to be cured with the (meth)acrylic ester compound. An adhesive agent made only of the phosphate ester compound or the metal salt thereof of Patent Document 1 is too high in fluidity, and cannot function as an adhesive agent.

It is an object of the present application to provide an adhesive composition that is capable of functioning alone as an adhesive component without using a curable resin, and adhering to integrate an inorganic material and an organic material, and to provide a composite material using the adhesive composition.

In order to solve the foregoing problem, the adhesive composition contains an adduct containing an acidic phosphate ester containing one or more kinds of compounds represented by General Formulae (1) and (2), and a metal,

P(═O)(—OR₁)(—OH)₂ (1)

P(═O)(—OR₁)₂(—OH) (2),

where R₁ represents an aliphatic hydrocarbon group having 4 to 30 carbon atoms, and has one or more branched chain structures, or one or more carbon-carbon double bond structures.

In this case, it is preferable that R₁ should be at least one selected from the group consisting of an oleyl group, an isostearyl group, a 2-ethylhexyl group, a butyloctyl group, an isomyristyl group, an isocetyl group, a hexyldecyl group, an octyldecyl group, an octyldodecyl group, and an isobehenyl group. It is preferable that the adhesive composition should have a pH of four or higher. Further, the adhesive composition may contain a solvent.

It is preferable that the metal should be a metal that forms a divalent or higher-valent metallic ion. It is preferable that the metal that forms the divalent or higher-valent metallic ion should be at least one metal selected from the group consisting of alkaline earth metals, aluminum, titanium, and zinc.

The composite material includes the above-described adhesive composition, and any one combination of an inorganic material and an organic material, inorganic materials, and organic materials, wherein the adhesive composition is disposed between the two materials to adhere to and integrate the two materials.

Since the adhesive composition contains the adduct containing the specific acidic phosphate ester and the metal, the adhesive composition is capable of functioning alone as an adhesive component without using a curable resin, and adhering to integrate the inorganic material and the organic material.

In this case, when having a pH of four or higher, an amount of the residual phosphate group (P—OH group) is sufficiently reduced. That is, since the adduct with the metal is formed in sufficient quantity, the adhesive composition has a viscosity sufficient to deliver desired adherence properties, and thus can sufficiently exhibit the effect as an adhesive composition.

The composition containing only the phosphate ester compound or the metal salt thereof described in Patent Document 1 increases in fluidity when heated, and cannot function as an adhesive agent, so the composition is poor also in heat resistance. For example, some automotive parts are used in a high temperature environment of 80° C. or higher, so that superior heat resistance is required also of an adhesive agent used to bond the materials in such a case. If the metal that forms the adduct with the specific acidic phosphate ester is a metal that forms a divalent or higher-valent metallic ion, the adhesive agent is superior also in heat resistance.

### BRIEF DESCRIPTION OF DRAWINGS

FIG. 1 is a schematic diagram of a composite material according to one embodiment of the present invention.

FIGS. 2A to 2C are schematic diagrams of a method for evaluating adherence properties.

FIG. 3 is a chart showing the temperature dependence of the storage elastic modulus of adducts containing isostearyl acid phosphate and metals.

### DESCRIPTION OF EMBODIMENTS

Next, an embodiment will be described in detail.

The adhesive composition according to the embodiment (hereinafter, referred to also as the present adhesive composition) contains an adduct containing an acidic phosphate ester containing one or more kinds of compounds represented by General Formulae (1) and (2), and a metal,

P(═O)(—OR₁)(—OH)₂ (1)

P(═O)(—OR₁)₂(—OH) (2),

where R₁ represents an aliphatic hydrocarbon group having 4 to 30 carbon atoms, and has one or more branched chain structures, or one or more carbon-carbon double bond structures.

Examples of the acidic phosphate ester in the present adhesive composition include an acidic phosphate ester containing only a compound represented by General Formula (1), an acidic phosphate ester containing only a compound represented by General Formula (2), and an acidic phosphate ester containing both of a compound represented by General Formula (1) and a compound represented by General Formula (2).

The adduct containing the acidic phosphate ester and the metal in the present adhesive composition include an adduct containing only the compound represented by General Formula (1) and the metal, an adduct containing only the compound represented by General Formula (2) and the metal, and an adduct containing both of the adduct containing the compound represented by General Formula (1) and the metal and the adduct containing the compound represented by General Formula (2) and the metal.

The adhesive composition is designed to effectively adhere to a wide range of materials ranging from inorganic materials to organic materials by utilizing the physical adsorption by van der Waals' forces. In order to make the physical adsorption act effectively, the adhesive composition is provided with certain fluidity so as to be excellent in wettability with respect to an adherend surface. To be specific, the adhesive composition is not completely solidified on the adherend surface. When the composition material is completely solidified on an adherend surface, the contact surface is reduced by the stress of the composition material, and the composition material is easily peeled off from the adherend surface. In addition, the adhesive composition is made to have a high viscosity in order to increase adhesion force because only to secure the adherend surface by having certain fluidity is insufficient. Thus, the adhesive composition is excellent in balance between fluidity and viscosity.

The adduct containing the acidic phosphate ester and the metal is capable of having both a phosphate group (polar group) and a nonpolar group (a hydrocarbon group in an ester moiety) in a molecule. The polar groups and the nonpolar groups can be present while being associated with each other in a layered state, so that the adduct can be made to be highly viscous liquid even though the adduct is a non-polymerized compound. Thus, the adhesive composition secures fluidity and high viscosity by containing the adduct containing the acidic phosphate ester and the metal, and having the specific aliphatic hydrocarbon group in its ester moiety.

In the acidic phosphate ester, R₁ represents an aliphatic hydrocarbon group having 4 to 30 carbon atoms, and has one or more branched chain structures, or one or more carbon-carbon double bond structures. The aliphatic hydrocarbon group is a chain alkyl group or a chain alkenyl group. It is assumed that viscosity is obtained in the aliphatic hydrocarbon group by the entanglement generated between the molecular chains. For this reason, an aliphatic hydrocarbon group is used instead of using an aromatic hydrocarbon group or an alicyclic hydrocarbon group from the viewpoint of obtaining viscosity. However, when the chain alkyl group is a straight chain alkyl group such as an n-butyl group and an n-octyl group, the alkyl groups are easily oriented, and increased in crystallinity to be likely to be solidified, and thus viscosity cannot be obtained. From this point of view, a chain alkyl group having one or more branched chain structures is used. Meanwhile, by having one or more carbon-carbon double bond structures, a chain alkenyl group is not high in crystallinity even if it is a straight chain alkenyl group, so that the chain alkenyl group may be a straight chain alkenyl group or a branched chain alkenyl group.

The acidic phosphate ester in which R₁ has less than four carbon atoms has an inorganic nature. In addition, the acidic phosphate ester is very likely to be crystallized. In other words, the acidic phosphate ester is likely to be solidified, and loses adherence properties (viscosity properties). The acidic phosphate ester in which R₁ has more than 30 carbon atoms is too high in viscosity, and cannot secure fluidity. From the viewpoint of adherence properties (viscosity properties), R₁ preferably has five or more carbon atoms, and more preferably six or more carbon atoms. From the viewpoint of fluidity, R₁ preferably has 26 or less carbon atoms, and more preferably 22 or less carbon atoms. The acidic phosphate ester in which R₁ has four or more carbon atoms, the tendency of this portion to non-polarization is high. Thus, the acidic phosphate ester has high compatibility with surfaces of materials with low polarity such as an organic material including a resin, among others, materials that have no polar group such as polyolefin such as polyethylene, polypropylene, and ethylene-a olefin copolymer and solid paraffin, or materials that have a polar group but small in quantity, and has increased adherence properties to the surfaces of the materials. From this point of view, R₁ preferably has five or more carbon atoms, and more preferably six or more carbon atoms.

Specific examples of R₁ include an oleyl group, an isostearyl group, a 2-ethylhexyl group, a butyloctyl group, an isomyristyl group, an isocetyl group, a hexyldecyl group, an octyldecyl group, an octyldodecyl group, and an isobehenyl group. The types of R₁ may be same between the compound represented by General Formula (1) and the compound represented by General Formula (2), or may be different. From the point of view of easy preparation of the composition, the types of R₁ are preferably same between the compound represented by General Formula (1) and the compound represented by General Formula (2).

Specific examples of the acidic phosphate ester include butyloctyl acid phosphate, isomyristyl acid phosphate, isocetyl acid phosphate, hexyldecyl acid phosphate, isostearyl acid phosphate, isobehenyl acid phosphate, octyldecyl acid phosphate, octyldodecyl acid phosphate, isobutyl acid phosphate, 2-ethylhexyl acid phosphate, isodecyl acid phosphate, tridecyl acid phosphate, oleyl acid phosphate, myristyl acid phosphate, palmityl acid phosphate, di-butyloctyl acid phosphate, di-isomyristyl acid phosphate, di-isocetyl acid phosphate, di-hexyldecyl acid phosphate, di-isostearyl acid phosphate, di-isobehenyl acid phosphate, di-octyl decyl acid phosphate, di-octyl dodecyl acid phosphate, di-isobutyl acid phosphate, di-2-ethylhexyl acid phosphate, di-isodecyl acid phosphate, di-tridecyl acid phosphate, di-oleyl acid phosphate, di-myristyl acid phosphate, and di-palmityl acid phosphate. Among them, oleyl acid phosphate and isostearyl acid phosphate are preferred from the viewpoint of viscosity properties and adherence properties.

The acidic phosphate ester needs to be contained in an adduct together with a metal. When using an acidic phosphate ester itself, which is not contained in an adduct together with the metal, is used, the polarity of the portion of the phosphate group is small, and the phosphate groups that are polar groups are low in associative properties (cohesive properties), and thus liquid having high viscosity cannot be obtained. For this reason, the adherence properties (viscosity properties) are low. In addition, even when the acidic phosphate ester is contained in an adduct together with ammonia or amine, the polarity of the portion of the phosphate group (amine salt) is small, and the phosphate groups (amine salts) that are polar groups are low in associative properties (cohesive properties), and thus liquid having high viscosity cannot be obtained. For this reason, the adherence properties (viscosity properties) are low.

The acidic phosphate ester itself is acidic, so that when the adherend material is a metallic material, corrosion is likely to build up. Also taking this into consideration, the acidic phosphate ester needs to be contained in an adduct together with a metal.

The present adhesive composition may partially contain an acidic phosphate ester itself, which is not contained in an adduct together with a metal, only if containing an adduct containing the specific acidic phosphate ester and a metal so as to have desired adherence properties. However, in the present adhesive composition, when the proportion of the acidic phosphate ester itself increases, the adherence properties (viscosity properties) is likely to be lowered, and corrosion is likely to build up. Thus, the proportion of the acidic phosphate ester itself is preferably smaller.

Examples of an index for measuring the ratio of the acidic phosphate ester itself includes measuring the pH of the present adhesive composition. When the ratio of the acidic phosphate ester increases, the residual amount of the phosphate group (P—OH group) increases, and the acidity becomes higher (the pH decreases). When the ratio of the acidic phosphate ester decreases, the residual amount of the phosphate group (P—OH group) decreases, and the acidity becomes lower (the pH increases). The pH of the present adhesive composition is preferably four or more, and more preferably 5.5 or more.

In addition, the ratio (molar ratio) of the specific acidic phosphate ester and the metal can be indicated by the value of f when assuming that f=1×x−m×y, where the valency of the acidic phosphate ester is x⁻, the valency of the metal is y⁺, the molar amount of the acidic phosphate ester is 1, and the molar amount of the metal is m. Within the range of f>0, the acidic phosphate ester is in excess of the metal, and the phosphate group (P—OH group) remains. When f=0, the acidic phosphate ester is equivalent to the metal, and no phosphate group (P—OH group) remains. In addition, When f<0, the acidic phosphate ester is insufficient for the metal, and no phosphate group (P—OH group) remains. In order to increase the pH of the present adhesive composition to improve the adherence properties of the adhesive composition, it is preferable that f≦0.

Examples of the metal include alkali metals such as Li, Na, and K, alkaline earth metals such as Mg and Ca, aluminum, titanium, and zinc. One kind of these metals may be used alone or two or more kinds may be used in combination. Among these metals, Li and Ca are preferred from the viewpoint of adhesive force and water resistance.

In addition, as the metal contained in the adduct, metals that form divalent or higher-valent metallic ions are preferred from the viewpoint of heat resistance. For example, a metal that forms a monovalent metallic ion merely forms an adduct with the acidic phosphate ester, in which the molar ratio of the phosphate group (P—OH group) to the metal is 1:1. The metal that forms divalent or higher-valent metallic ions can form an adduct with the acidic phosphate ester, in which the molar ratio of the phosphate group (P—OH group) to the metal is 2:1 or higher. In this case, two or more molecules of the acidic phosphate ester can form an adduct through one divalent or higher-valent metallic ion, so that the molecular mass of the adduct is larger than the molecular mass of the adduct formed with the monovalent metallic ion. It is assumed that is why the heat resistance of the adhesive composition is improved.

The heat resistance of the adhesive composition means that desired adherence properties can be maintained even under a heating condition, and the adherence properties are not reduced significantly even under a heating condition in comparison with the adherence properties at room temperature. The heating temperatures are room temperature (25° C.) or higher, for example, they are 40° C. or higher, 50° C. or higher, and 80° C. or higher. Having heat resistance at 80° C. or higher, the adhesive composition is excellent in suitability as automobile parts.

Examples of the metal that forms a divalent or higher-valent metallic ion include alkaline earth metals such as Mg and Ca, aluminum, titanium, and zinc. One kind of these metals may be used alone or two or more kinds may be used in combination. Among these metals, Ca and Mg are preferred from the viewpoint of adhesive force and water resistance.

The present adhesive composition may further contain a solvent. The solvent may be used from the viewpoint of enhancing the coating properties of the adhesive composition when applying the adhesive composition to an adherend surface, and from the viewpoint of securing the coating properties of the adhesive composition at low temperatures such as room temperature. The solvent may be a non-volatile solvent that remains in a coat formed by coating an adherend surface with the present adhesive composition to become a part of the coat, or may be a volatile solvent that volatilizes and does not remain in the coat and does not become a part of the coat. Examples of the non-volatile solvent include liquid paraffin (synthetic oil) and mineral oil. Examples of the volatile solvent include low molecular alkane such as hexane and isooctane, an aromatic solvent such as toluene and xylene, relatively low-polar alcohol such as benzyl alcohol and lauryl alcohol, an ether solvent such as tetrahydrofuran (THF) and ethylene glycol, a ketone solvent such as methyl ethyl ketone (MEK) and methyl isobutyl ketone (MIBK), an ester solvent such as ethyl acetate and butyl acetate, and a halogenous solvent such as chloroform and dichloroethane. Among these solvents, synthetic oil, isooctane, toluene, benzyl alcohol, and MEK are preferred from the viewpoint of dispersibility and solubility.

According to the present adhesive composition having the above configuration, by containing the adduct containing the specific acidic phosphate ester and the metal, the present adhesive composition is capable of functioning alone as an adhesive agent without combination with a curable resin, and adhering to integrate an inorganic material and an organic material. Since the present adhesive composition is capable of functioning alone as the adhesive component without combination with a curable resin, cure treatment for curing the present adhesive composition by heat, light, moisture or the like after applied is unnecessary.

In addition, when the metal contained in the adduct is a metal that forms a divalent or higher-valent metallic ion, the present adhesive composition can stand in a high temperature environment of 80° C. or higher, and is thus excellent in suitability for automobile parts, for example.

Next, a description of the composite material according to the present invention will be provided.

The composite material includes the adhesive composition, and any one combination of an inorganic material and an organic material, inorganic materials, and organic materials, where the adhesive composition is disposed between the two materials to adhere to and integrate the two materials.

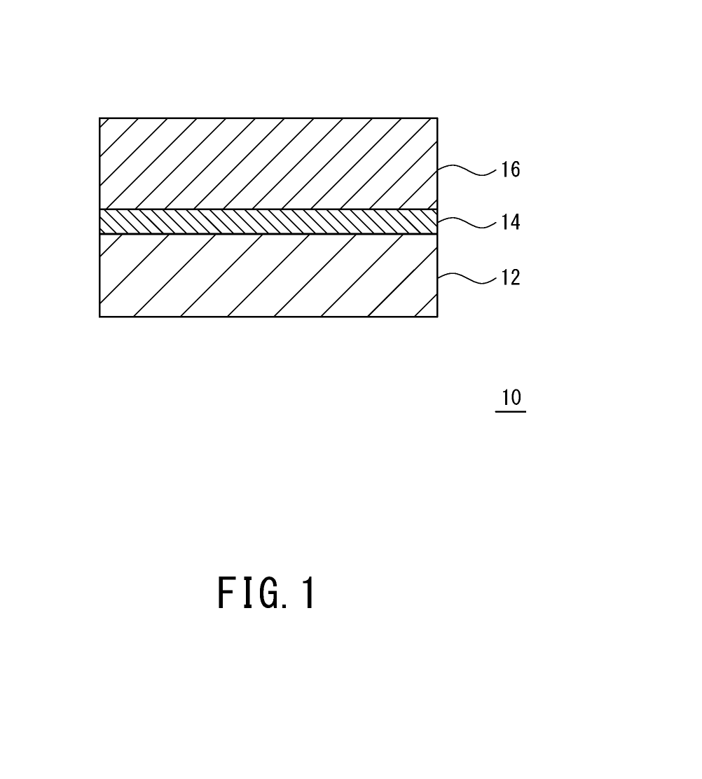

FIG. 1 is a cross-sectional view of the composite material according to one embodiment. As shown in FIG. 1, the composite material 10 includes one material 12, another material 16, and an adhesive composition 14 disposed between the materials 12 and 16 to adhere to the materials 12 and 16, the one material 12 and the other material 16 being integrated by the adhesive composition 14. The adhesive composition 14 is made of the adhesive composition. Each of the one material 12 and the other material 16 is in the form of solid.

The one material 12 is an inorganic material made of an inorganic compound such as a metal and a metal oxide, an inorganic material made of a layer of an inorganic compound such as a metal and a metal oxide that is formed on a surface of an organic material, or an organic material made of an organic polymer such as a resin (plastic) and rubber, or solid paraffin. The other material 16 is an inorganic material made of an inorganic compound such as a metal and a metal oxide, an inorganic material made of a layer of an inorganic compound such as a metal and a metal oxide that is formed on a surface of an organic material, or an organic material made of an organic polymer such as a resin (plastic) and rubber, or solid paraffin. Each of the inorganic material and the organic material is in the form of solid.

The metal as the inorganic compound is not limited specifically; however, examples thereof include Cu, Sn, Fe, Zn, Ni, Al, Ag, and Au. Examples of the metal oxide as the inorganic compound include oxides of the above-described metals, a magnesium oxide, a titanium oxide, and a calcium oxide. Examples of the inorganic compound include a metal-containing compound and a silicon-containing compound such as talc, calcium carbonate, kaolin, silica, and mica.

Examples of the resin (plastic) as the organic polymer include polyolefins such as a polyethylene polypropylene ethylene-α-olefin copolymer, polystyrene, polyester, polyamide, polyurethane, and poly(meth)acrylate. Examples of the rubber as the organic polymer include butadiene rubber, isoprene rubber, chloroprene rubber, and natural rubber.

Examples of the combination of the one material 12 and the other material 16 include a combination where the one material 12 is an inorganic material and the other material 16 is an inorganic material, a combination where the one material 12 is an inorganic material and the other material 16 is an organic material, a combination where the one material 12 is an organic material and the other material 16 is an inorganic material, and a combination where the one material 12 is an organic material and the other material 16 is an organic material. In the combination where the one material 12 is an inorganic material and the other material 16 is an inorganic material, the inorganic materials may be made of a same kind of inorganic compounds, or may be made of different kinds of inorganic compounds. In the combination where the one material 12 is an organic material and the other material 16 is an organic material, the organic materials may be made of a same kind of organic polymers (polymers) or solid paraffin, or may be made of different kinds of organic polymers (polymers) or solid paraffin.

Among these combinations, the combination where the one material 12 is an inorganic material and the other material 16 is an organic material, and the combination where the one material 12 is an organic material and the other material 16 is an inorganic material are preferred. In these combinations, examples of the inorganic compound as the inorganic material include a metal. Examples of the organic material include an organic polymer such as a resin (plastic) and rubber, and solid paraffin. Examples of the metal include Cu, Sn, Fe, Zn, Ni, Al, Ag, and Au. As the organic polymer, an organic polymer with a relatively low polarity that has no polar group, or has a polar group but small in quantity is preferred because the adhesive composition contains the adduct containing the specific acidic phosphate ester and the metal, in which the cohesive phase of the phosphate group (polar group) increases the adherence properties with the surface of the inorganic material while the cohesive phase of the nonpolar group (a hydrocarbon group in an ester moiety) increases the adherence properties with the surface of the organic material. Preferred examples of the organic polymer include a polyolefin such as a polyethylene polypropylene ethylene-α-olefin copolymer, and solid paraffin.

In the combination where the one material 12 is an organic material and the other material 16 is an organic material, it is preferable that the one organic material should be an organic polymer with a relatively high polarity while the other organic material should be an organic polymer with a relatively low polarity or solid paraffin. Examples of the organic polymer with a relatively high polarity include polyamide, polyester, polyvinyl chloride, polyurethane, and poly(meth)acrylate.

Specific examples of the use of the composite material 10 include a variety of joints for electric and electronic parts and small equipment, waterproofing packing parts, and surface coating parts.

The composite material 10 can be obtained, for example, by applying the adhesive composition according to the present invention to an adhering surface of either one of the one material 12 and the other material 16, and then adhering to integrate the one material 12 and the other material 16 while sandwiching the adhesive composition between them. Alternatively, the composite material 10 can be obtained by applying the adhesive composition to a surface of the one material 12, and then applying the organic polymer for the other material 16 on the surface of the applied adhesive composition to form a layer of the organic polymer. In the former case, the adhesive composition functions as an adhesive agent to adhere to the (preformed) one material 12 and the (preformed) other material 16. In the latter case, the adhesive composition functions as a primer for applying to form the organic polymer for the other material 16 on a surface of the (preformed) one material 12.

The adhesive composition may be applied as it is at room temperature, or may be heated before applied so as to have a suitable viscosity.

### EXAMPLES

Hereinafter, a description will be provided with reference to examples; however, the present invention is not limited to the examples.

### Synthesis of the Present Adhesive Compositions

### Synthesis Example 1

### OL-Li

50 g (acid value of 0.163 mol) of oleyl acid phosphate (“Phoslex A18D” manufactured by SC ORGANIC CHEMICAL CO., LTD., molecular mass of 467 (average), acid value of 183 mg KOH/g) and 50 mL of methanol were placed in a 500 mL flask, and were stirred at 50° C. to yield a uniform solution. A solution obtained by dissolving 6.84 g (0.163 mol) of lithium hydroxide monohydrate anhydrous in 50 mL of methanol was gradually added thereto. The resulting clear solution was stirred for 30 minutes while keeping the temperature at 50° C., and then the methanol and the generated water were distilled off under reduced pressure using a rotary evaporator. Then, after the addition of 50 mL of toluene, the mixture was distilled in the same manner to distill the generated water off by azeotrope, and then the product of interest that was a clear viscous substance was obtained.

### Synthesis Example 2

### OL-Ca

50 g (acid value of 0.163 mol) of oleyl acid phosphate (“Phoslex A18D” manufactured by SC ORGANIC CHEMICAL CO., LTD., molecular mass of 467 (average), acid value of 183 mg KOH/g) and 50 mL of methanol were placed in a 500 mL flask, and were stirred at room temperature to yield a uniform solution. 6.04 g (0.0815 mol) of calcium hydroxide was added thereto, and the resulting suspension was stirred for 24 hours while being kept at room temperature. After it was confirmed that a deposition of the calcium hydroxide disappeared, the mixture was filtered, and then the methanol and the generated water were distilled off under reduced pressure using a rotary evaporator. Then, after the addition of 50 mL of toluene, the mixture was distilled in the same manner to distill the generated water off by azeotrope, and then the product of interest that was a clear viscous substance was obtained.

### Synthesis Example 3

### IS-Li

The product of interest that was a clear viscous substance was obtained in the same manner as in Synthesis Example 1, except that 50 g (acid value of 0.159 mol) of isostearyl acid phosphate (“Phoslex A18OL” manufactured by SC ORGANIC CHEMICAL CO., LTD., molecular mass of 487 (average), acid value of 178 mg KOH/g) was used instead of oleyl acid phosphate, and 6.67 g (0.159 mol) of lithium hydroxide monohydrate anhydrous was added thereto.

### Synthesis Example 4

### IS-Ca

The product of interest that was a clear viscous substance was obtained in the same manner as in Synthesis Example 2, except that 50 g (acid value of 0.159 mol) of isostearyl acid phosphate (“Phoslex A18OL” manufactured by SC ORGANIC CHEMICAL CO., LTD., molecular mass of 487 (average), acid value of 178 mg KOH/g) was used instead of oleyl acid phosphate, and 5.89 g (0.0795 mol) of calcium hydroxide was added thereto.

### Synthesis Example 5

### IS-Mg

The product of interest that was a clear viscous substance was obtained in the same manner as in Synthesis Example 4, except that 4.64 g (0.0795 mol) of magnesium hydroxide was added thereto instead of 5.89 g (0.0795 mol) of calcium hydroxide.

### Synthesis Example 6

### IS-Zn

The product of interest that was a clear viscous substance was obtained in the same manner as in Synthesis Example 4, except that 8.73 g (0.0795 mol as Zn) of basic zinc carbonate was added thereto instead of 5.89 g (0.0795 mol) of calcium hydroxide.

### Synthesis Example 7

### IS-Al

The product of interest that was a clear viscous substance was obtained in the same manner as in Synthesis Example 3, except that 10.83 g (0.053 mol) of aluminum isopropoxide was added thereto instead of the lithium hydroxide monohydrate anhydrous/methanol solution.

### Synthesis Example 8

### EH-Li

The product of interest that was a clear viscous substance was obtained in the same manner as in Synthesis Example 3, except that 50 g (acid value of 0.153 mol) of di-2-ethylhexyl acid phosphate (“Phoslex A-208” manufactured by SC ORGANIC CHEMICAL CO., LTD., molecular mass of 322 (average), acid value of 172 mg KOH/g) was used instead of isostearyl acid phosphate, and 6.42 g (0.153 mol) of lithium hydroxide monohydrate anhydrous was added thereto.

### Synthesis Example 9

### EH-Ca

The product of interest that was a clear viscous substance was obtained in the same manner as in Synthesis Example 4, except that 50 g (acid value of 0.153 mol) of di-2-ethylhexyl acid phosphate (“Phoslex A-208” manufactured by SC ORGANIC CHEMICAL CO., LTD., molecular mass of 322 (average), acid value of 172 mg KOH/g) was used instead of isostearyl acid phosphate, and 5.67 g (0.076 mol) of calcium hydroxide was added thereto.

### Synthesis Example 10

### EH-Mg

The product of interest that was a clear viscous substance was obtained in the same manner as in Synthesis Example 5, except that 50 g (acid value of 0.153 mol) of di-2-ethylhexyl acid phosphate (“Phoslex A-208” manufactured by SC ORGANIC CHEMICAL CO., LTD., molecular mass of 322 (average), acid value of 172 mg KOH/g) was used instead of isostearyl acid phosphate, and 4.46 g (0.076 mol) of magnesium hydroxide was added thereto.

### Synthesis Example 11

### EH-Zn

The product of interest that was a clear viscous substance was obtained in the same manner as in Synthesis Example 6, except that 50 g (acid value of 0.153 mol) of di-2-ethylhexyl acid phosphate (“Phoslex A-208” manufactured by SC ORGANIC CHEMICAL CO., LTD., molecular mass of 322 (average), acid value of 172 mg KOH/g) was used instead of isostearyl acid phosphate, and 8.34 g (0.076 mol as Zn) of basic zinc carbonate was added thereto.

### Synthesis Example 12

### EH-Al

The product of interest that was a clear viscous substance was obtained in the same manner as in Synthesis Example 7, except that 50 g (acid value of 0.153 mol) of di-2-ethylhexyl acid phosphate (“Phoslex A-208” manufactured by SC ORGANIC CHEMICAL CO., LTD., molecular mass of 322 (average), acid value of 172 mg KOH/g) was used instead of isostearyl acid phosphate, and 10.4 g (0.051 mol) of aluminum isopropoxide was added thereto.

### Synthesis Example 18

### IS-K

The product of interest that was a clear viscous substance was obtained in the same manner as in Synthesis Example 3, except that 8.92 g (0.159 mol) of potassium hydroxide was used instead of 6.67 g (0.159 mol) of lithium hydroxide monohydrate anhydrous.

### Synthesis of Comparative Adhesive Compositions

### Synthesis Example 13

### MT-Li

The product of interest was obtained in the same manner as in Synthesis Example 1, except that 25 g (acid value of 0.315 mol) of methyl acid phosphate (“Phoslex A-1” manufactured by SC ORGANIC CHEMICAL CO., LTD., molecular mass of 119 (average), acid value of 707 mg KOH/g) was used instead of oleyl acid phosphate, and 13.2 g (0.315 mol) of lithium hydroxide monohydrate anhydrous was added thereto.

### Synthesis Example 14

### MT-Ca

The product of interest was obtained in the same manner as in Synthesis Example 2, except that 25 g (acid value of 0.315 mol) of methyl acid phosphate (“Phoslex A-1” manufactured by SC ORGANIC CHEMICAL CO., LTD., molecular mass of 119 (average), acid value of 707 mg KOH/g) was used instead of oleyl acid phosphate, and 11.67 g (0.157 mol) of calcium hydroxide was added thereto.

### Synthesis Example 15

### ST-Ca

The product of interest was obtained in the same manner as in Synthesis Example 2, except that 50 g (acid value of 0.203 mol) of n-stearyl acid phosphate (“Phoslex A18” manufactured by SC ORGANIC CHEMICAL CO., LTD., molecular mass of 437 (average), acid value of 228 mg KOH/g) was used instead of oleyl acid phosphate, 200 mL of methanol was added thereto, and 7.53 g (0.1015 mol) of calcium hydroxide was added thereto.

### Synthesis Example 16

### BU-Zn

The product of interest was obtained in the same manner as in Synthesis Example 6, except that 25 g (acid value of 0.119 mol) of di-n-butyl phosphate (manufactured by WAKO PURE CHEMICAL INDUSTRIES, LTD., molecular mass of 210.2) was used instead of isostearyl acid phosphate, 200 mL of methanol was added thereto, and 6.53 g (0.0595 mol) of basic zinc carbonate was added thereto.

### Synthesis Example 17

### IS-TEA

The product of interest was obtained in the same manner as in Synthesis Example 4, except that 16.09 g (0.159 mol) of triethylamine was used instead of calcium hydroxide.

### Production and Adhesive Evaluations of Composite Materials

### Examples 1 to 12

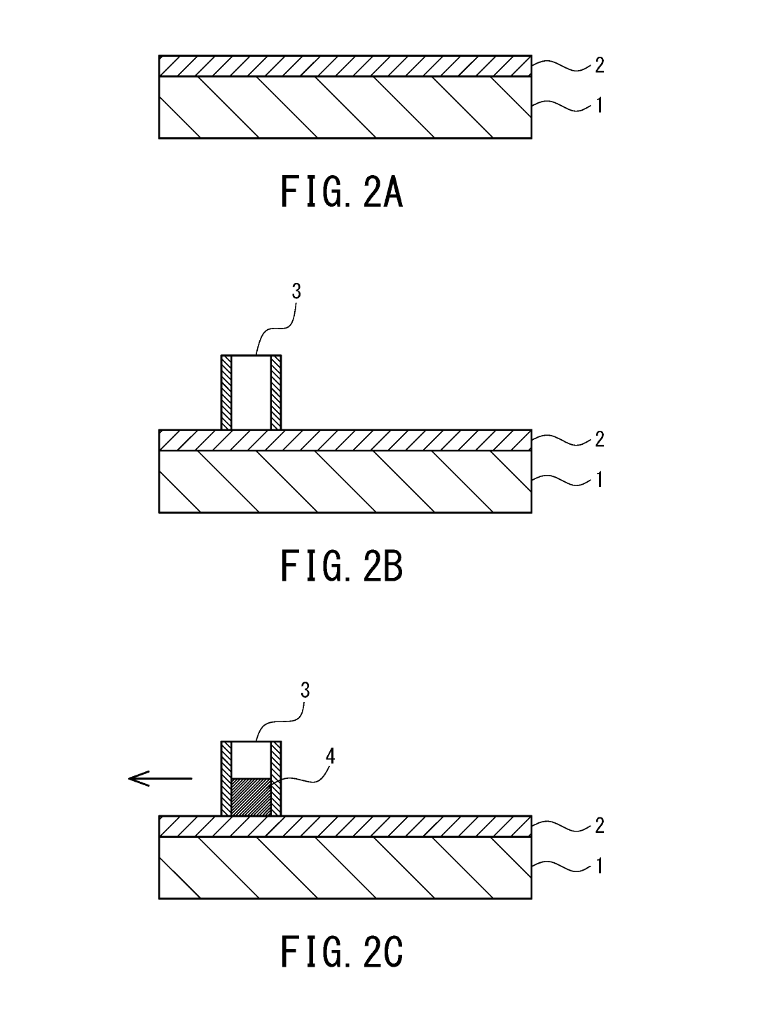

2 mass % of toluene solution was prepared by adding toluene to each of the adhesive compositions of Synthesis Examples 1 to 12. A metal plate (15 mm×80 mm×1 mmt, made of Cu) was immersed in each of the toluene solutions to be immediately pulled out, and air dried over three hours, and thus each adhesive composition 2 was applied to each metal plate 1 as shown in FIG. 2A. Then, a copper pipe 3 (6 mm in diameter) was placed on each adhesive composition 2 with its open end facing the adhesive surface as shown in FIG. 2B. Then, a fused material of resin was poured into the copper pipe 3 (contact area of 28.3 mm²) as shown in FIG. 2C. Then, after the resin inside the copper pipe 3 was naturally cooled to room temperature to be solidified, a shear tensile test was performed in a manner such that while each metal plate 1 was fixed, the resin 4 solidified on the adhesive surface was pulled in the horizontal direction together with the copper pipe 3 at room temperature (25° C.) as shown in FIG. 2C, and the adherence properties at 25° C. of the adhesive compositions 2 were evaluated based on the shear forces (N) at this time.

Resin: Polyethylene (PE), “polyethylene Mw=to 4000” manufactured by SIGMA-ALDRICH CO. LLC.

### Examples 13, 15, and 17

Production and adhesive evaluations of composite materials of Examples 13, 15, and 17 were made in the same manner as in Examples 4, 6, and 11, except that the materials of the metal plates were changed from Cu to Sn.

### Examples 14, 16, and 18

Production and adhesive evaluations of composite materials of Examples 14, 16, and 18 were made in the same manner as in Examples 4, 6, and 11, except that solid paraffin (SP) instead of a resin was solidified inside the pipe 3.

Solid paraffin: “Paraffin (having a melting point of 68 to 70° C.)” manufactured by “WAKO PURE CHEMICAL INDUSTRIES, LTD.

### Comparative Examples 1, 2, and 3

Production and adhesive evaluations of composite materials of Comparative Examples 1, 2, and 3 were made in the same manner as in Examples 4, 13, and 14, except that the metal plates 1 were used with no adhesive composition 2 applied thereto.

### Comparative Examples 4 and 5

Production and adhesive evaluations of composite materials of Comparative Examples 4 and 5 were made in the same manner as in Examples 4 and 8, except that an acidic phosphate ester itself was used without using a metal salt thereof. In the tables, ISP and EHP respectively indicate isostearyl acid phosphate (“Phoslex A18OL” manufactured by SC ORGANIC CHEMICAL CO., LTD., molecular mass of 487 (average), acid value of 178 mg KOH/g) and di-2-ethylhexyl acid phosphate (“Phoslex A-208” manufactured by SC ORGANIC CHEMICAL CO., LTD., molecular mass of 322 (average), acid value of 172 mg KOH/g) themselves.

### Comparative Examples 6, 7, 8, and 9

Production and adhesive evaluations of composite materials of Comparative Examples 6, 7, 8, and 9 were made in the same manner as in Examples 1, 2, 2, and 6, except that the comparative compositions of Synthesis Examples 13, 14, 15, and 16 were used instead of the adhesive compositions of Synthesis Examples 1, 2, 2, and 6.

### Comparative Example 10

Production and adhesive evaluations of a composite material of Comparative Example 10 were made in the same manner as in Example 4, except that an amine salt of an acidic phosphate ester (Synthesis Example 17) was used without using a metal salt thereof.

### Measurement of pH

The pH of each composition was measured. Each composition was suspended in pure water in a proportion of about 3% (w/v) by ultrasonic irradiation, and the pH of the suspension was measured using a pH meter equipped with a glass electrode.

TABLE 1

| | | Synthesis | | Example | | | | | | | | |
|---|---|---|---|---|---|---|---|---|---|---|---|---|
| | | Example | pH | 1 | 2 | 3 | 4 | 5 | 6 | 7 | 8 | 9 |
| Adhesive | OL-Li | 1 | 7.2 | 100 | | | | | | | | |
| composition | OL-Ca | 2 | 7.3 | | 100 | | | | | | | |
| | IS-Li | 3 | 7.3 | | | 100 | | | | | | |
| | IS-Ca | 4 | 7.2 | | | | 100 | | | | | |
| | IS-Mg | 5 | 7.4 | | | | | 100 | | | | |
| | IS-Zn | 6 | 7.3 | | | | | | 100 | | | |
| | IS-Al | 7 | 7.1 | | | | | | | 100 | | |
| | EH-Li | 8 | 7.2 | | | | | | | | 100 | |
| | EH-Ca | 9 | 7.2 | | | | | | | | | 100 |
| | EH-Mg | 10 | 7.1 | | | | | | | | | |
| | EH-Zn | 11 | 7.3 | | | | | | | | | |
| | EH-Al | 12 | 7.4 | | | | | | | | | |
| Comparative | ISP | — | 3.1 | | | | | | | | | |
| composition | EHP | — | 3.0 | | | | | | | | | |
| | MT-Li | 13 | 7.1 | | | | | | | | | |
| | MT-Ca | 14 | 7.3 | | | | | | | | | |
| | ST-Ca | 15 | 7.4 | | | | | | | | | |
| | BU-Zn | 16 | 7.1 | | | | | | | | | |
| | IS-TEA | 17 | 7.1 | | | | | | | | | |
| Resin/Solid paraffin | | | | PE | PE | PE | PE | PE | PE | PE | PE | PE |
| Metal plate | | | | Cu | Cu | Cu | Cu | Cu | Cu | Cu | Cu | Cu |
| Shear force (N) | | | | 17.5 | 16.2 | 21.1 | 20.5 | 20.1 | 18.8 | 17.6 | 17.1 | 17.9 |
| | | Synthesis | | Example | | | | | | | | |
| | | Example | pH | 10 | 11 | 12 | 13 | 14 | 15 | 16 | 17 | 18 |
| Adhesive | OL-Li | 1 | 7.2 | | | | | | | | | |
| composition | OL-Ca | 2 | 7.3 | | | | | | | | | |
| | IS-Li | 3 | 7.3 | | | | | | | | | |
| | IS-Ca | 4 | 7.2 | | | | 100 | 100 | | | | |
| | IS-Mg | 5 | 7.4 | | | | | | | | | |
| | IS-Zn | 6 | 7.3 | | | | | | 100 | 100 | | |
| | IS-Al | 7 | 7.1 | | | | | | | | | |
| | EH-Li | 8 | 7.2 | | | | | | | | | |
| | EH-Ca | 9 | 7.2 | | | | | | | | | |
| | EH-Mg | 10 | 7.1 | 100 | | | | | | | | |
| | EH-Zn | 11 | 7.3 | | 100 | | | | | | 100 | 100 |
| | EH-Al | 12 | 7.4 | | | 100 | | | | | | |
| Comparative | ISP | — | 3.1 | | | | | | | | | |
| composition | EHP | — | 3.0 | | | | | | | | | |
| | MT-Li | 13 | 7.1 | | | | | | | | | |
| | MT-Ca | 14 | 7.3 | | | | | | | | | |
| | ST-Ca | 15 | 7.4 | | | | | | | | | |
| | BU-Zn | 16 | 7.1 | | | | | | | | | |
| | IS-TEA | 17 | 7.1 | | | | | | | | | |

| | | | | | | | | | |
|---|---|---|---|---|---|---|---|---|---|
| Resin/Solid paraffin | PE | PE | PE | PE | PE | PE | PE | PE | PE |
| Metal plate | Cu | Cu | Cu | Sn | Cu | Sn | Cu | Sn | Cu |
| Shear force (N) | 17.3 | 16.2 | 16.2 | 17.5 | 14.1 | 18.2 | 14.6 | 15.9 | 13.9 |

PE: Polyethylene,
SP: Solid paraffin,
Cu: Copper,
Sn: Tin

TABLE 2

| | | Synthesis | | Comparative Example | | | | | | | | | |
|---|---|---|---|---|---|---|---|---|---|---|---|---|---|
| | | Example | pH | 1 | 2 | 3 | 4 | 5 | 6 | 7 | 8 | 9 | 10 |
| Adhesive | OL-Li | 1 | 7.2 | | | | | | | | | | |
| composition | OL-Ca | 2 | 7.3 | | | | | | | | | | |
| | IS-Li | 3 | 7.3 | | | | | | | | | | |
| | IS-Ca | 4 | 7.2 | | | | | | | | | | |
| | IS-Mg | 5 | 7.4 | | | | | | | | | | |
| | IS-Zn | 6 | 7.3 | | | | | | | | | | |
| | IS-Al | 7 | 7.1 | | | | | | | | | | |
| | EH-Li | 8 | 7.2 | | | | | | | | | | |
| | EH-Ca | 9 | 7.2 | | | | | | | | | | |
| | EH-Mg | 10 | 7.1 | | | | | | | | | | |
| | EH-Zn | 11 | 7.3 | | | | | | | | | | |
| | EH-Al | 12 | 7.4 | | | | | | | | | | |
| Comparative | ISP | — | 3.1 | | | | 100 | | | | | | |
| composition | EHP | — | 3.0 | | | | | 100 | | | | | |
| | MT-Li | 13 | 7.1 | | | | | | 100 | | | | |
| | MT-Ca | 14 | 7.3 | | | | | | | 100 | | | |
| | ST-Ca | 15 | 7.4 | | | | | | | | 100 | | |
| | BU-Zn | 16 | 7.1 | | | | | | | | | 100 | |
| | IS-TEA | 17 | 7.1 | | | | | | | | | | 100 |

| | | | | | | | | | | |
|---|---|---|---|---|---|---|---|---|---|---|
| Resin/Solid paraffin | PE | PE | PE | PE | PE | PE | PE | PE | PE | PE |
| Metal plate | Cu | Sn | Cu | Cu | Cu | Cu | Cu | Cu | Cu | Cu |
| Shear force (N) | 0.6 | 0.5 | 0.2 | 1.4 | 1.1 | 1.6 | 1.7 | 0.5 | 1.0 | 0.5 |

PE: Polyethylene,
SP: Solid paraffin,
Cu: Copper,
Sn: Tin

As shown in Table 1, it is found that the composite materials of Examples 1 to 18 have sufficient shear forces on the contact interfaces between the resins or solid paraffin and the metals, and each of the adhesive compositions functions sufficiently as an adhesive agent.

In contrast, it is found that in the composite materials of Comparative Examples 1 to 3, since the adhesive compositions do not exist on the contact interfaces between the resins or solid paraffin and the metals, the shear forces on the contact interfaces are low. It is found that in the composite materials of Comparative Examples 4 to 5, since the acidic phosphate ester is used without using a metal salt thereof, the adhesive compositions have low cohesive properties between the polar portions, and do not have sufficient viscosity as an adhesive agent, and thus the composite materials of Comparative Examples 4 to 5 have low shear forces on the contact interfaces. It is found that in the composite material of Comparative Example 6, since the alkyl group in the acidic phosphate ester is too short, the adhesive composition is likely to be crystallized to have no viscosity, and thus the composite material of Comparative Example 6 has a low shear force on the contact interface. It is found that in the composite materials of Comparative Examples 7 to 9, since the alkyl groups in the acidic phosphate ester have no branched chain structure or carbon-carbon double bond structure, the compositions are likely to be crystallized to have no viscosity, and thus the composite materials of Comparative Examples 7 to 9 have low shear forces on the contact interfaces. It is found that in the composite material of Comparative Example 10, since the amine salt of the acidic phosphate ester is used without using a metal salt thereof, the composition has a low cohesive force to have no viscosity, and thus the composite material of Comparative Example 10 has a low shear force on the contact interface.

### Experimental Examples 1A to 8A

2 mass % of toluene solution was prepared by adding toluene to each of the adhesive compositions of Synthesis Examples 2, 4 to 7, and 9 to 11. A metal plate (15 mm×80 mm×1 mmt, made of Cu) was immersed in each of the toluene solutions to be immediately pulled out, and air dried over three hours, and thus each adhesive composition 2 was applied to each metal plate 1 as shown in FIG. 2A. Then, a copper pipe 3 (6 mm in diameter) was placed on each adhesive composition 2 with its open end facing the adhesive surface as shown in FIG. 2B. Then, a fused material of resin was poured into the copper pipe 3 (contact area of 28.3 mm²) as shown in FIG. 2C. Then, the resin inside the copper pipe 3 was naturally cooled to room temperature to be solidified. Thus, the composite materials were produced. Then, a shear tensile test was performed in a manner such that while each metal plate 1 was fixed, the resin 4 solidified on the adhesive surface was pulled in the horizontal direction together with the copper pipe 3 at room temperature (25° C.) as shown in FIG. 2C, and the adherence properties at 25° C. of the adhesive compositions 2 were evaluated based on the shear forces (N) at this time. In addition, after each produced composite material was left in a constant temperature bath of 80° C. for two hours, a similar shear tensile test was performed under the environment of 80° C., and the adherence properties at 80° C. of the adhesive compositions 2 were evaluated based on the shear forces (N) at this time.

Resin: Polyethylene (PE), “polyethylene Mw=to 4000” manufactured by SIGMA-ALDRICH CO. LLC.

### Experimental Examples 9A to 12A

Production and adhesive evaluations of composite materials of Experimental Examples 9A to 12A were made in the same manner as in Experimental Examples 1A to 3A, and 5A, except that the materials of the metal plates were changed from Cu to Sn.

### Experimental Examples 1B to 4B

Production and adhesive evaluations of composite materials of Experimental Examples 1B to 4B were made in the same manner as in Experimental Examples 1A to 4A, except that the adhesive compositions of Synthesis Examples 1, 3, 8, and 18 were used instead of the adhesive compositions of Synthesis Examples 2, 4, 9, and 5.

### Experimental Examples 5B to 6B

Production and adhesive evaluations of composite materials of Experimental Examples 5B to 6B were made in the same manner as in Experimental Examples 1A and 9A, except that the metal plates 1 were used without applying the adhesive compositions 2 thereto.

### Experimental Example 7B

Production and adhesive evaluation of a composite material of Experimental Example 7B were made in the same manner as in Experimental Example 2A, except that acidic phosphate ester was used without using a metal salt thereof. In the tables, ISP indicates isostearyl acid phosphate (“Phoslex A18OL” manufactured by SC ORGANIC CHEMICAL CO., LTD., molecular mass of 487 (average), acid value of 178 mg KOH/g) itself

### Experimental Examples 8B and 9B

Production and adhesive evaluations of composite materials of Experimental Examples 8B and 9B were made in the same manner as in Experimental Example 2A, except that the comparative compositions of Synthesis Examples 14 and 15 were used instead of the adhesive composition of Synthesis Example 4.

### Experimental Example 10B

Production and adhesive evaluations of a composite material of Experimental Example 10B were made in the same manner as in Experimental Example 2A, except that the amine salt of acidic phosphate ester (Synthesis Example 17) was used without using a metal salt thereof.

### Experimental Example 11B

Production and adhesive evaluations of a composite material of Experimental Example 11B were made in the same manner as in Experimental Example 2A, except that the hydrogenated rosin (“ESTER GUM H” manufactured by ARAKAWA CHEMICAL INDUSTRIES, LTD., EGH) was used instead of the present adhesive composition.

### Measurement of pH

The pH of each composition was measured. Each composition was suspended in pure water in a proportion of about 3% (w/v) by ultrasonic irradiation, and the pH of the suspension was measured using a pH meter equipped with a glass electrode.

### Viscoelasticity Evaluations

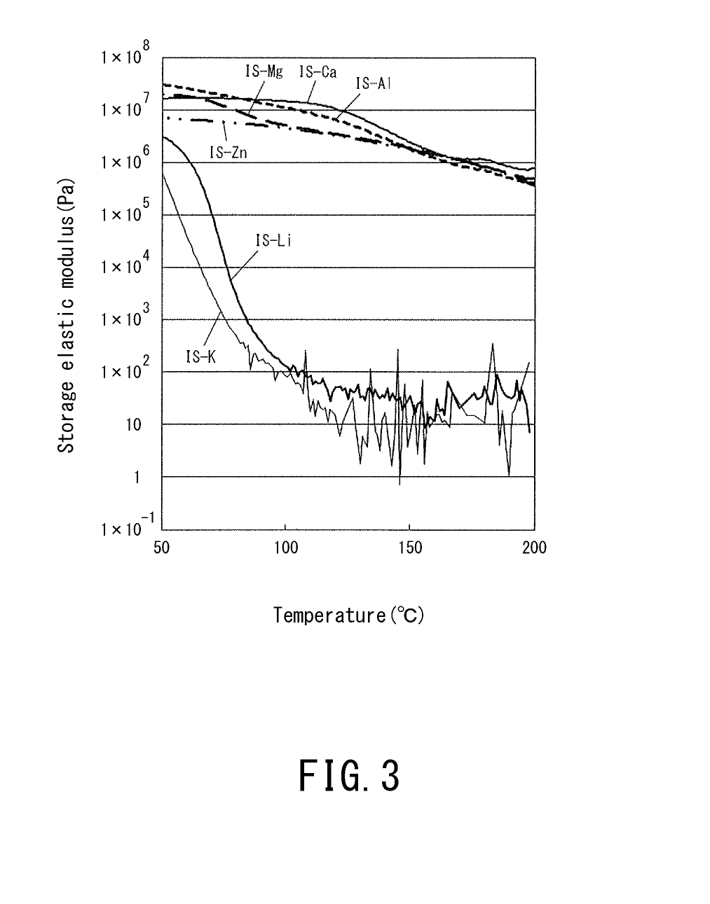

In connection with the heat resistance of the adhesive compositions, by using isostearyl acid phosphate as an example of acidic phosphate ester, the temperature dependence of the storage elastic modulus of each adduct containing isostearyl acid phosphate and each metal was examined. Results of the examinations are shown in FIG. 3. It is to be noted that the measurements of storage elastic moduli were carried out using a rotational rheometer. Measurement conditions are a swing width γ: 1%, and frequency: 1 Hz. The adducts that were synthesized in the adhesive compositions of Synthesis Example 4 (IS-Ca), Synthesis Example 5 (IS-Mg), Synthesis Example 6 (IS-Zn), Synthesis Example 7 (IS-Al), Synthesis Example 3 (IS-Li), and Synthesis Example 18 (IS-K) were used, and while the temperature of each sample of 0.5 g was being lowered at a rate of 5° C./min from 200° C., the storage viscoelasticity of each sample was measured.

TABLE 3

| | | Synthesis | | Experimental Example | | | | | | | | | | | |
|---|---|---|---|---|---|---|---|---|---|---|---|---|---|---|---|
| | | Example | pH | 1A | 2A | 3A | 4A | 5A | 6A | 7A | 8A | 9A | 10A | 11A | 12A |
| Adhesive | OL-Ca | 2 | 7.3 | 100 | | | | | | | | 100 | | | |
| composition | IS-Ca | 4 | 7.2 | | 100 | | | | | | | | 100 | | |
| | EH-Ca | 9 | 7.2 | | | 100 | | | | | | | | 100 | |
| | IS-Mg | 5 | 7.4 | | | | 100 | | | | | | | | 100 |
| | IS-Zn | 6 | 7.3 | | | | | 100 | | | | | | | |
| | IS-Al | 7 | 7.1 | | | | | | 100 | | | | | | |
| | EH-Mg | 10 | 7.1 | | | | | | | 100 | | | | | |
| | EH-Zn | 11 | 7.3 | | | | | | | | 100 | | | | |
| | OL-Li | 1 | 7.2 | | | | | | | | | | | | |
| | IS-Li | 3 | 7.3 | | | | | | | | | | | | |
| | EH-Li | 8 | 7.2 | | | | | | | | | | | | |
| | IS-K | 18 | 7.3 | | | | | | | | | | | | |
| Comparative | ISP | — | 3.1 | | | | | | | | | | | | |
| composition | MT-Ca | 14 | 7.3 | | | | | | | | | | | | |
| | ST-Ca | 15 | 7.3 | | | | | | | | | | | | |
| | IS-TEA | 17 | 7.1 | | | | | | | | | | | | |
| | EGH | — | — | | | | | | | | | | | | |

| | | | | | | | | | | | | |
|---|---|---|---|---|---|---|---|---|---|---|---|---|
| Resin | PE | PE | PE | PE | PE | PE | PE | PE | PE | PE | PE | PE |
| Metal plate | Cu | Cu | Cu | Cu | Cu | Cu | Cu | Cu | Sn | Sn | Sn | Sn |
| Adherence properties at 25° C. | 16.1 | 20.2 | 17.5 | 20.2 | 18.8 | 17.5 | 17.0 | 16.0 | 17.9 | 17.3 | 17.1 | 16.1 |
| (Shear force) (N) | | | | | | | | | | | | |
| Adherence properties at 80° C. | 15.1 | 16.4 | 16.9 | 17.7 | 12.1 | 11.5 | 16.4 | 11.4 | 14.5 | 14.4 | 16.2 | 11.2 |
| (Shear force) (N) | | | | | | | | | | | | |

PE: Polyethylene

TABLE 4

| | | Synthesis | | Experimental Example | | | | | | | | | | |
|---|---|---|---|---|---|---|---|---|---|---|---|---|---|---|
| | | Example | pH | 1B | 2B | 3B | 4B | 5B | 6B | 7B | 8B | 9B | 10B | 11B |
| Adhesive | OL-Ca | 2 | 7.3 | | | | | | | | | | | |
| composition | IS-Ca | 4 | 7.2 | | | | | | | | | | | |
| | EH-Ca | 9 | 7.2 | | | | | | | | | | | |
| | IS-Mg | 5 | 7.4 | | | | | | | | | | | |
| | IS-Zn | 6 | 7.3 | | | | | | | | | | | |
| | IS-Al | 7 | 7.1 | | | | | | | | | | | |
| | EH-Mg | 10 | 7.1 | | | | | | | | | | | |
| | EH-Zn | 11 | 7.3 | | | | | | | | | | | |
| | OL-Li | 1 | 7.2 | 100 | | | | | | | | | | |
| | IS-Li | 3 | 7.3 | | 100 | | | | | | | | | |
| | EH-Li | 8 | 7.2 | | | 100 | | | | | | | | |
| | IS-K | 18 | 7.3 | | | | 100 | | | | | | | |
| Comparative | ISP | — | 3.1 | | | | | | | 100 | | | | |
| composition | MT-Ca | 14 | 7.3 | | | | | | | | 100 | | | |
| | ST-Ca | 15 | 7.3 | | | | | | | | | 100 | | |
| | IS-TEA | 17 | 7.1 | | | | | | | | | | 100 | |
| | EGH | — | — | | | | | | | | | | | 100 |

| | | | | | | | | | | | |
|---|---|---|---|---|---|---|---|---|---|---|---|
| Resin | PE | PE | PE | PE | PE | PE | PE | PE | PE | PE | PE |
| Metal plate | Cu | Cu | Cu | Cu | Cu | Sn | Cu | Cu | Cu | Cu | Cu |
| Adherence properties at 25° C. | 17.5 | 20.5 | 18.0 | 17.6 | 0.5 | 0.5 | 1.6 | 1.9 | 0.8 | 0.6 | 9.8 |
| (Shear force) (N) | | | | | | | | | | | |
| Adherence properties at 80° C. | 2.4 | 2.6 | 2.5 | 2.1 | 0.4 | 0.4 | 1.0 | 0.6 | 0.4 | 0.4 | 2.1 |
| (Shear force) (N) | | | | | | | | | | | |

PE: Polyethylene

As shown in Table 3, the composite materials of Experimental Examples 1A to 12A contain the adducts containing the specific acidic phosphate esters and the metals that form a divalent or higher-valent metallic ion, and it is found that the composite materials of Experimental Examples 1A to 12A have sufficient shear forces of 10N or more both at room temperature (25° C.) and under heating (80° C.) on the contact interfaces between the resins and the metals, where no reduction in shear force is seen even under heating (80° C.) in comparison with room temperature (25° C.). Therefore, it is found that each of the adhesive compositions functions sufficiently as an adhesive agent, and has good heat resistance.

Meanwhile, the composite materials of Experimental Examples 1B to 4B contain the adducts containing the specific acidic phosphate esters and the metals that form a metallic ion having a monovalence, and it is found that while having sufficient shear forces at room temperature (25° C.), the composite materials of Experimental Examples 1B to 4B have shear forces under heating (80° C.) that are greatly reduced (3N or less), and have inferior heat resistance. It is found that the composite materials of Experimental Examples 5B to 6B have low shear forces even at room temperature (25° C.) on the contact interfaces between the resins and the metals since the adhesive composition does not exist on the contact interfaces. It is found that in the composite material of Experimental Example 7B, since the acidic phosphate ester is used without using a metal salt thereof, the adhesive composition has low cohesive properties between the polar portions, and does not have sufficient viscosity as an adhesive agent, and thus the composite material of Experimental Example 7B has a low shear force (3N or less) even at room temperature (25° C.) on the contact interface. It is found that in the composite material of Experimental Example 8B, since the alkyl group in the acidic phosphate ester is too short, the adhesive composition is likely to be crystallized to have no viscosity, and thus the composite material of Experimental Example 8B has a low shear force (3N or less) even at room temperature (25° C.) on the contact interface. It is found that in the composite material of Experimental Example 9B, since the alkyl group in the acidic phosphate ester has no branched chain structure or carbon-carbon double bond structure, the composition is likely to be crystallized to have no viscosity, and thus the composite material of Experimental Example 9B has a low shear force (3N or less) even at room temperature (25° C.) on the contact interface. It is found that in the composite material of Experimental Example 10B, since while the specific acidic phosphate ester and the amine component (triethylamine) form the adduct, the amine salt of the acidic phosphate ester itself has a low cohesive force to have no viscosity, and thus the composite material of Experimental Example 10B has a low shear force (3N or less) even at room temperature (25° C.) on the contact interface. It is found that in the composite material of Experimental Example 11B, the hydrogenated rosin that is an adhesive component is a nonpolar component to be low in viscosity to a metal at room temperature (25° C.), and has a softening point of 80° C. or less to have inferior heat resistance.

As shown in FIG. 3, it is found that the viscoelasticity of the adhesive compositions at high temperatures (50 to 200° C.) greatly varies with the type of the metals that form the adducts although the same acidic phosphate esters having the same alkyl chains are used. To be specific, when the metal forming the adduct is Li or K that forms a monovalent metallic ion, the storage elastic moduli decrease remarkably as the temperature goes up higher from the vicinity of 60° C., resulting in the storage elastic moduli of less than 100 Pa at the vicinity of 100° C. Meanwhile, when the metal forming the adduct is Ca, Mg, Zn, or Al that forms a divalent or higher-valent metallic ion, the decreases of the storage elastic moduli are small even when the temperature goes up higher (to 200° C.) from the vicinity of 60° C., indicating the storage elastic moduli of about 10⁷ Pa at the vicinity of 100° C., and the storage elastic moduli of about 10⁶ Pa even at the vicinity of 200° C. It is found from these results that when a metal that forms a divalent or higher-valent metallic ion is used for the metals that form the adducts together with the acidic phosphate esters, the adhesive compositions are high in heat resistance.

While the embodiment has been described in detail, the present invention is not limited to the above-described embodiment, and various modifications can be made without departing from the gist of the present invention.

1. An adhesive composition comprising an adduct comprising:
an acidic phosphate ester comprising one or more kinds of compounds represented by General Formulae (1) and (2); and
a metal,
P(═O)(—OR₁)(—OH)₂ (1)
P(═O)(—OR₁)₂(—OH) (2),
where R₁ represents an aliphatic hydrocarbon group having 4 to 30 carbon atoms, and has one or more branched chain structures, or one or more carbon-carbon double bond structures.

2. The adhesive composition according to claim 1,
wherein R₁ comprises at least one selected from the group consisting of an oleyl group, an isostearyl group, a 2-ethylhexyl group, a butyloctyl group, an isomyristyl group, an isocetyl group, a hexyldecyl group, an octyldecyl group, an octyldodecyl group, and an isobehenyl group.

3. The adhesive composition according to claim 2, having a pH of four or higher.

4. The adhesive composition according to claim 3, wherein the metal comprises a metal that forms a divalent or higher-valent metallic ion.

5. The adhesive composition according to claim 4, wherein the metal that forms the divalent or higher-valent metallic ion comprises at least one metal selected from the group consisting of alkaline earth metals, aluminum, titanium, and zinc.

6. The adhesive composition according to claim 5, further comprising a solvent.

7. A composite material comprising:
the adhesive composition according to claim 5; and
any one combination of an inorganic material and an organic material, inorganic materials, and organic materials,
wherein the adhesive composition is disposed between the two materials to adhere to and integrate the two materials.

8. The adhesive composition according to claim 1, having a pH of four or higher.

9. The adhesive composition according to claim 1, wherein the metal comprises a metal that forms a divalent or higher-valent metallic ion.

10. The adhesive composition according to claim 9, wherein the metal that forms the divalent or higher-valent metallic ion comprises at least one metal selected from the group consisting of alkaline earth metals, aluminum, titanium, and zinc.

11. The adhesive composition according to claim 1, further comprising a solvent.

12. A composite material comprising:
the adhesive composition according to claim 1; and
any one combination of an inorganic material and an organic material, inorganic materials, and organic materials,
wherein the adhesive composition is disposed between the two materials to adhere to and integrate the two materials.
